(19) United States
(12) Patent Application Publication
(10) Pub. No.: US 2024/0220806 A1
(43) Pub. Date: Jul. 4, 2024

(54) RECALCULATION METHOD OF BACKPROPAGATION IN A MANNER THAT SELECT THE LAYERS TO STORE THE OUTPUT IN MEMORY

(71) Applicant: Research & Business Foundation Sungkyunkwan University, Suwon-si (KR)

(72) Inventors: Euiseong SEO, Suwon-si (KR); Osama KHAN, Suwon-si (KR); Gwanjong PARK, Suwon-si (KR)

(73) Assignee: Research & Business Foundation Sungkyunkwan University, Suwon-si (KR)

(21) Appl. No.: 18/398,458

(22) Filed: Dec. 28, 2023

(30) Foreign Application Priority Data
Dec. 28, 2022 (KR) 10-2022-0186977

(51) Int. Cl. G06N 3/084

(52) U.S. Cl. CPC G06N 3/084

(57) ABSTRACT

A recalculation method of backpropagation for selecting layers to store outputs in a memory includes partitioning the entire layers of a model including layers into segments, assigning ranks to the segments, storing outputs of the last layers of first segments with the highest assigned rank among the segments in the memory simultaneously, changing the values stored in the memory, which removes, from the memory, output values of the last segments of the first segments stored in the memory after recalculation of backpropagation is performed on the first segments and stores output values of the last layers of second segments, of which the assigned rank immediately follows the rank of the first segments, in the memory simultaneously, and repeating the changing of the values stored in the memory until output values of the last layers of third segments with the lowest assigned rank are stored in the memory simultaneously.

### CROSS REFERENCE TO RELATED APPLICATIONS

This application claims the benefit under 35 USC 119 of Korean Patent Application No. 10-2022-0186977, filed on Dec. 28, 2022, in the Korean Intellectual Property Office, the entire disclosure of which is incorporated herein by reference for all purposes.

### TECHNICAL FIELD

The present disclosure relates to a recalculation method of backpropagation for selecting layers to store output in a memory and, more particularly, to a recalculation method of backpropagation, which partitions the entire layers of a model into segments, assigns ranks to the segments, and stores output values of related layers in the memory.

### BACKGROUND

Backpropagation requires to store intermediate outputs from all layers obtained during forward pass calculations in a memory. Meanwhile, the limited SRAM capacity of a microcontroller prevents it from storing outputs from all layers to perform the backpropagation operation. In this case, although a flash memory may be employed to store the outputs from the entire layers, a loss occurs in terms of energy and time.

FIG. 1 illustrates a procedure of backpropagation operation through the conventional recalculation method.

In one embodiment according to the prior art, backpropagation may be performed for a model with four layers, including two convolution layers (designated as C1 and C2 in FIG. 1) and two fully connected layers (designated as F1 and F2 in FIG. 1).

Specifically, with reference to FIG. 1, in step 1 (see Steps in FIG. 1, in what follows, no further indication will be given on the steps), given input data, forward pass calculation is performed through a network, and output is calculated. Afterward, the error is calculated, and the F2 layer is updated. However, the output of the F1 layer is required to update the weights of the F2 layer. In step 2, since the output of the F1 layer is discarded during the first forward pass calculation, the forward pass calculation is performed again from the start of the network, and output of the F1 layer is calculated. In step 3, the output of the F1 layer is used to update the weights of the F2 layer. In step 4, forward pass calculation is performed again to update the weights of the F1 layer, and the output of the C2 layer is calculated. In steps 5 to 8, the process of steps 1 to 4 is performed repeatedly until the update of the entire network is completed.

In this way, when a memory budget is given, backpropagation through the conventional recalculation method selects a portion of layers to be stored in the memory but discards all outputs from layers other than the selected layers, and the output of the discarded layers is recalculated when needed for the backpropagation process. Accordingly, additional computational costs are incurred.

Therefore, there is a need for an algorithm that may identify the optimal checkpoint for recalculation and efficiently store it in the memory, considering the memory budget and computational cost of each layer.

### SUMMARY

To solve the problem of the prior art described above, the present disclosure provides a recalculation method of backpropagation, which partitions the entire layers of a model into segments, assigns ranks to the segments, and stores output values of related layers in the memory.

A recalculation method of backpropagation for selecting layers to store outputs in a memory according to a first characteristic of the present disclosure comprises partitioning the entire layers of a model including a plurality of layers into segments; assigning ranks to the segments; storing outputs of the last layers of first segments with the highest assigned rank among the segments in the memory simultaneously; changing the values stored in the memory, which removes, from the memory, output values of the last segments of the first segments stored in the memory after recalculation of backpropagation is performed on the first segments and stores output values of the last layers of second segments, of which the assigned rank immediately follows the rank of the first segments, in the memory simultaneously; and repeating the changing of the values stored in the memory until output values of the last layers of third segments with the lowest assigned rank are stored in the memory simultaneously.

A recording medium readable by a digital processing device, in which a program of commands executed by the digital processing device to provide recalculation of backpropagation for selecting layers to store outputs in a memory according to a second characteristic of the present disclosure is implemented, records a program in a computer, the program executing a recalculation method of backpropagation for selecting layers to store outputs in the memory according to the first characteristic of the present disclosure in a computer.

A recalculation method of backpropagation for selecting layers to store outputs in a memory according to an embodiment of the present disclosure provides the following effects.

The recalculation method according to the present disclosure partitions the entire layers of a model into segments, where the method configures an algorithm to minimize a recalculation cost calculated based on the number of floating-point operations per second of the layers for all possible cases of subsets.

Also, the recalculation method according to the present disclosure assigns ranks to the segments, stores outputs of the last layers of the segments with the highest rank in the memory simultaneously, and after performing recalculation of backpropagation on the corresponding segments, changes the values stored in the memory to the output values of the last layers of the segments with the next rank, thereby maximizing the memory efficiency.

To summarize, the recalculation method according to the present disclosure employs a backtracking method to find the optimal checkpoints for recalculation by considering the memory budget and calculation cost of each layer, wherein the method implements an algorithm that stores output of a portion of the checkpoints at a specific time point in the memory to further improve the memory efficiency, replaces the current checkpoints with other checkpoints as backpropagation progresses, assigns different ranks to the respective checkpoints, and stores the checkpoint outputs of the same rank in the memory simultaneously.

Accordingly, without employing auxiliary flash memory which may be problematic in terms of latency and power consumption issues, the present disclosure may achieve a model update using a microcontroller in a memory-constrained environment.

### BRIEF DESCRIPTION OF THE DRAWINGS

FIG. 1 illustrates a procedure of backpropagation operation through the conventional recalculation method.

FIG. 2 illustrates a recalculation procedure of backpropagation for selecting layers to store output in a memory according to an embodiment of the present disclosure.

FIG. 3 illustrates a method for partitioning the entire layers of a model into segments by considering the possible cases of subsets according to an embodiment of the present disclosure.

FIG. 4 illustrates a procedure for building all possible subsets from a set comprising four elements using a tree structure according to an embodiment of the present disclosure.

FIG. 5 is a table showing an additional computational cost for each rank of a model partitioned into four segments according to an embodiment of the present disclosure.

FIG. 6 illustrates an algorithm for optimally classifying the entire layers of a model into segments according to an embodiment of the present disclosure.

FIG. 7 illustrates an algorithm for determining ranks of classified segments according to an embodiment of the present disclosure.

FIG. 8 is a graph showing the amount of time and energy consumed to performed backpropagation for five types of models according to an embodiment of the present disclosure.

FIG. 9 is a graph comparing a recalculation method according to the prior art, a recalculation method according to an embodiment of the present disclosure, and a method using flash memory for a model with 22 layers according to one embodiment of the present disclosure.

FIG. 10 is a graph illustrating normalized values of five publicly available DNN models according to an embodiment of the present disclosure.

FIG. 11 illustrates a DNN model consisting of four layers that is illustrative of a recalculation cost for a single segment.

### DETAILED DESCRIPTION

In what follows, the present disclosure will be described in detail with reference to embodiments and appended drawings. However, it should be noted that the detailed description is not intended to limit the present disclosure to the specific embodiment; also, if it is determined that a detailed description of the prior art related to the present disclosure obscures the gist of the present disclosure, the detailed description thereof will be omitted.

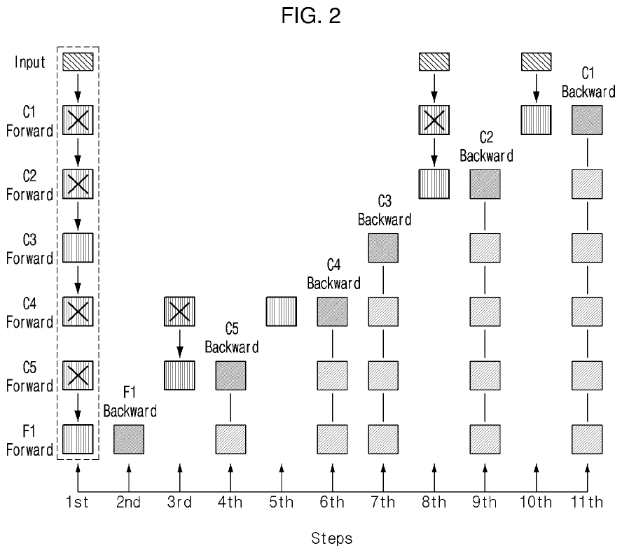

FIG. 2 illustrates a recalculation procedure of backpropagation for selecting layers to store output in a memory according to an embodiment of the present disclosure.

According to one embodiment of the present disclosure, backpropagation of a model that includes six layers consisting of five convolution layers (designated as C1 to C5 in FIG. 2) and one fully connected layer (designated as F1 in FIG. 2) may be performed. It should be noted that C3 and F1 layer correspond to the outputs of segment 1 (which includes C1 to C3 layers) and segment 2 (which includes C4 to F1 layers), respectively.

Specifically, with reference to FIG. 2, in step 1 (see Steps in FIG. 2, in what follows, no further indication will be given on the steps), given input data, forward pass calculation is performed through a network, and output is calculated, where segment outputs (i.e., outputs of C2 and F1 layers) are stored in the memory. In steps 2 to 3, the output of C5 layer is required to update the weights of F1 layer. Since the output of the C3 layer is already stored, the output of C5 layer is calculated by performing forward pass calculations from and after the C4 layer. In steps 4 and 5, the output of C4 layer is calculated to update the weights of C5 layer. In step 6, to update the weights of C4 layer, the pre-stored output of C3 layer may be utilized. In steps 7 to 11, the process of steps 1 to 6 is performed repeatedly until the update of the entire network is completed.

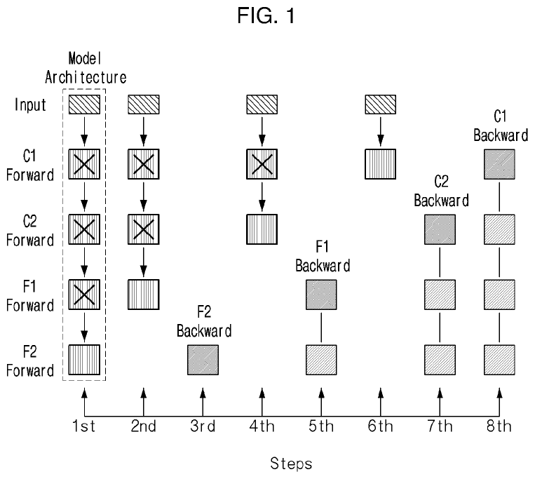

Since a method of storing the checkpoint output in the memory through segment partitioning is used, a portion of the process, which involves repeating the forward pass calculations from the beginning of the network to update layers, is omitted unlike the method of FIG. 1, where the omission further increases the efficiency.

As described above, it is necessary to know the computational cost of all layers for segment partitioning so that backpropagation is performed with the minimal recalculation cost. According to the embodiment of the present disclosure, the computational cost of a layer may be calculated based on the number of floating point operations per second (FLOPs) of the layer. FLOPs serve as a metric for assessing the computational burden related to layer calculations. More specifically, it indicates that a layer with a large number of FLOPs demands more computational operations compared to a layer with fewer FLOPs.

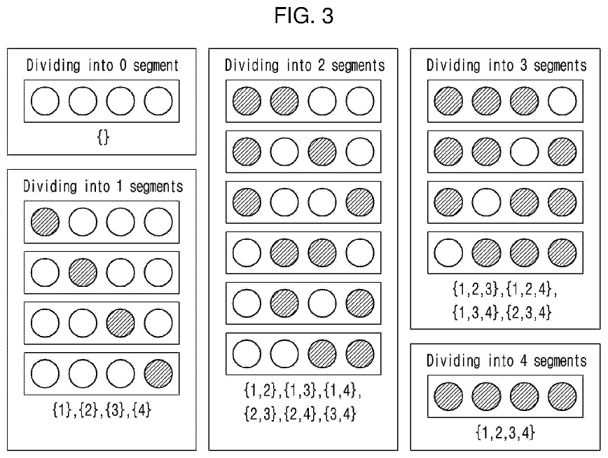

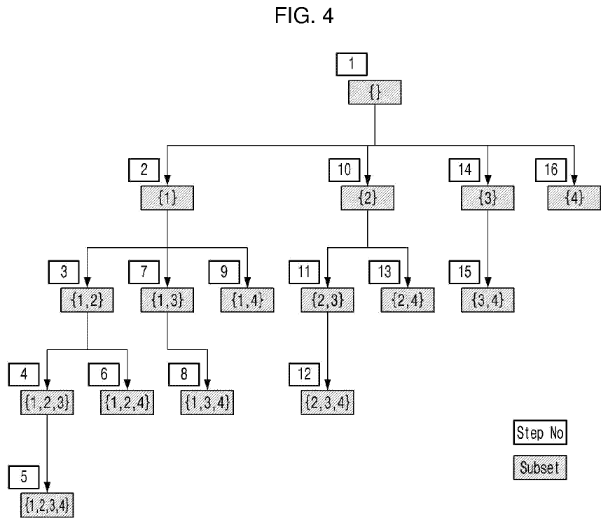

FIG. 3 illustrates a method for partitioning the entire layers of a model into segments by considering the possible cases of subsets according to an embodiment of the present disclosure, and FIG. 4 illustrates a procedure for building all possible subsets from a set comprising four elements using a tree structure according to an embodiment of the present disclosure.

According to an embodiment of the present disclosure, a method for partitioning the entire layers of a model into segments may be performed as follows.

Partitioning a model into segments may be equivalent to constructing all possible subsets of a set consisting of n elements. For example, all possible subsets of a set S consisting of four elements (e.g., S={1, 2, 3, 4}) are { }, {1}, {2}, {3}, {4}, {1,2}, {1,3}, {1,4}, {2,3}, {2,4}, {3,4}, {1,2,3}, {1,2,4}, {1,3,4}, {2,3,4}, and {1,2,3,4}. The case of all possible subsets corresponds to the case of possible segment partitioning.

The tree structure of FIG. 4 shows a procedure of constructing all possible subsets of a set consisting of four elements. In the example, a single partitioning method is used to construct all possible subsets, where all possible partitioning methods are generated, and a method that yields the minimum recalculation cost among the generated methods is selected.

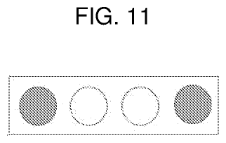

For a model consisting of four layers, an illustrative calculation of the recalculation cost for a single segment is provided in the case of segmentation as shown in FIG. 11 (i.e., partitioning of the model into layer 1 and layers 2 to 4).

It should be noted that shaded circles (shown in FIG. 11) represent the last layer of each segment, and ‘segment output’ refers to the output of the last layer of the segment throughout the present disclosure.

$$\\ \begin{matrix}Recomputation cost of segment 1 ⩵ Cost of layer 1 \times recomputing\_times = 20 \times 1 = 20 & [ Eq . 1 ]\end{matrix}$$

$$\\ \begin{matrix}Recomputation cost of segment 2 ⩵ Cost of layer 2 \times recomputing\_times + cost of layer 3 \times recomputing\_times + cost of layer 4 \times recomputing\_times = ( 15 \times 2 ) + ( 10 \times 1 ) + 5 = 45 & [ Eq . 2 ]\end{matrix}$$

$$\\ \begin{matrix}Total Recomputaion cost ⩵ Recomputation cost of segment 1 + Recomputation cost of segment 2 = 20 + 45 = 65 & [ Eq . 3 ]\end{matrix}$$

In addition to the recalculation cost above, additional costs may be required. For example, if the amount of available memory is 100 KB, the output of both segments may not be stored. Therefore, first, the output of segment 2 is stored. When the output of segment 2 is no longer needed, the output of segment 2 stored in memory is removed, and the output of segment 1 is stored instead. In this case, additional costs may be incurred for recalculation of segment 1. The final cost is 85 (=20+45+20), and the cost of segmentation for the corresponding model becomes 85.

According to the embodiment of the present disclosure, ranks may be assigned to all segments to find additional costs. The rank assignment is necessary for the following reason. Based on the ranks, additional costs may be determined at the time of segment partitioning, and rank information may be used to determine whether segment outputs may be stored in the memory simultaneously.

According to the embodiment of the present disclosure, segments of the same rank may store their output in the memory simultaneously when implementing recalculation. Segments are assigned ranks in reverse order, and when backpropagation moves from a higher-ranked segment to a lower-ranked segment (e.g., from Rank 1 to Rank 2), outputs of all segments with a rank equal to or lower than that of the moved segment are recalculated. In the example above where a model is partitioned into layer 1 and layers 2 to 4, the rank of segment 1 is 2 (i.e., Rank 2), and the rank of segment 2 is 1 (i.e., Rank 1). When backpropagation moves from the segment of rank 1 to the segment of rank 2, outputs of segments with a rank equal to or lower than rank 2 are recalculated. In the above example, only the output of segment 1 is recalculated.

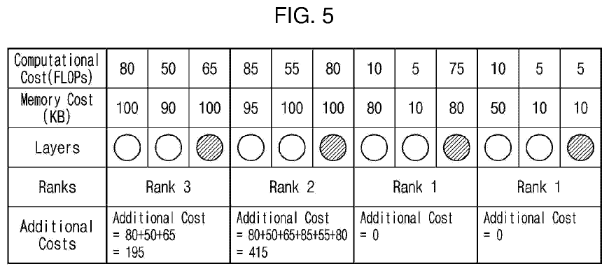

FIG. 5 is a table showing an additional computational cost for each rank of a model partitioned into four segments according to an embodiment of the present disclosure.

To assign a rank to each segment, all segments are traversed in reverse order, and the size of the segment output (i.e., the output of the last layer of the segment) is subtracted from the available memory size. Ranks are assigned in ascending order, starting from 1, where 1 is the highest rank. If the available memory capacity becomes smaller than zero after the subtraction operation, the rank is lowered by one level, and the available memory size is set to its original value.

In an exemplary embodiment, if the memory is 100 KB, and outputs of segment 1 and segment 2 are 100 KB and 5 KB, respectively, the ranks of the two segments may be assigned in the following order.

Since the output of segment 2 is 5 KB, the available memory becomes 95 KB (=100 KB−5 KB). Segment 2 is assigned Rank 1. If backpropagation moves to the previous segment, segment 1, the available memory becomes −5 KB (=95 KB−100 KB); since the available memory is less than 0, the rank is lowered by one level, segment 2 is assigned Rank 2, and the available memory size is set to its original size.

Therefore, according to the embodiment of the present disclosure, the additional cost may be obtained by adding the costs of searching all segments in reverse order and, upon a rank change, calculating the outputs of all segments with a rank equal to or lower than a changed rank (e.g., if the changed rank is Rank 2, Rank 2 and ranks lower than Rank 2). Referring to FIG. 5, an exemplary method of calculating additional costs is shown for a model consisting of 12 layers and partitioned into 4 segments.

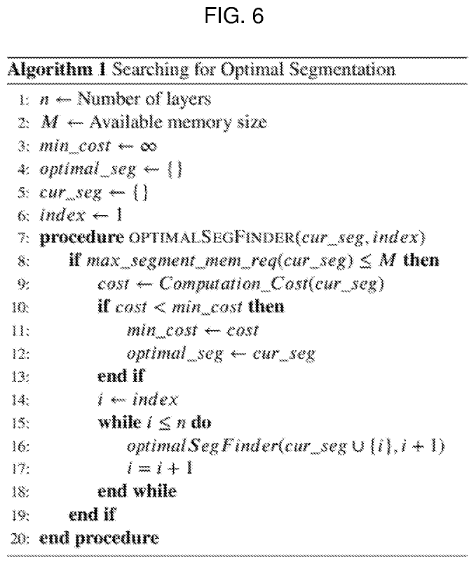

FIG. 6 illustrates an algorithm for optimally classifying the entire layers of a model into segments according to an embodiment of the present disclosure.

In rows 1 to 6, the algorithm for optimal segmentation initializes the number of layers in the model, available memory size, minimum cost, an empty set to maintain the optimal segmentation, the current segment, and an index initialized to 1. Rows 7 to 19 correspond to the optimalSegFinder function, where two arguments are passed to call the function. The first argument may be an empty set at startup, and the second argument may be an index initialized to 1. The function incrementally generates all subsets of a set with n elements (i.e. S={1, 2, . . . , n}). The subsets are created in the same way as described above with reference to FIGS. 3 and 4.

More specifically, Algorithm 1 in FIG. 6 searches for the optimal segmentation method. After initializing the necessary variables up to row 6, the algorithm calls the optimalSegFinder function at row 7. In the first call, an empty set and an index initialized to 1 are passed to the function, and the function in turn calls max_segment_mem_req to check whether the largest checkpoint in the given segmentation scheme may be allocated to the available memory size M.

If the attempt fails, cur_seg is skipped, and optimalSegFinder returns without performing any additional work. If the output may be accommodated within the memory size according to the current segmentation scheme, the function replaces optimize_seg with cur_seg if the recalculation cost of cur_seg is less than the smallest recalculation cost observed up to the current time point and performs the optimal segmentation out of the segmentation methods explored so far. optimalSegFinder derives a series of segmentation schemes using the depth-first search method and calls optimalSegFinder for each segmentation.

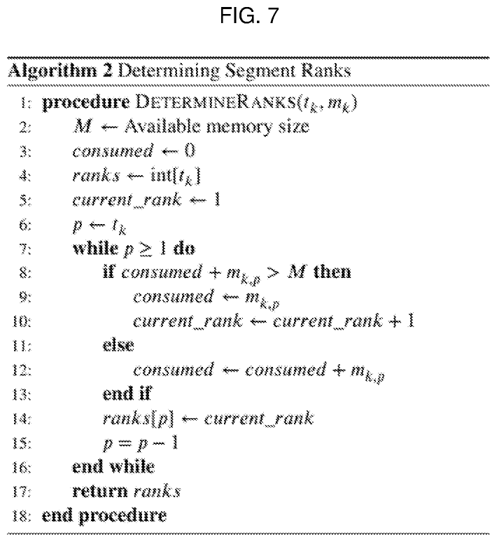

FIG. 7 illustrates an algorithm for determining ranks of classified segments according to an embodiment of the present disclosure.

In the algorithm for determining segment ranks according to an embodiment of the present disclosure, the function determines the ranks of all segments according to a segmentation method. tₖ represents the number of segments in the segmentation method, and mₓ is a list that stores all output sizes of all segments.

The function initializes variables. M is the size of available memory. consumed is set to 0, and ranks is an array that stores the ranks of all segments. current_rank is initialized to 1, and p is initialized to the number of segments in the segmentation method.

For all segments, the output size is added to the variable consumed, and it is checked whether the output size exceeds the available memory size M. If the output size exceeds the available memory size, consumed is set to the output size of the current segment, and current_rank is increased by 1. If the output size does not exceed the available memory size, the output size of the current segment is added to the variable consumed, and the rank of the segment is also set to current_rank each time the operation above is repeated.

More specifically, Algorithm 2 of FIG. 7 shows a method for determining segment ranks. mₖ is a list of memory requirements of each segment under sₖ. It should be noted that sₖ corresponds to the k-th element of the set S, which includes all possible cases of partitioning a model into segments. The function RankFinder receives tₖ and mₖ as parameters, initializes the variables, and iterates through the segments in reverse order starting from the last segment. consumed represents the current SRAM usage and is initially 0. If the available memory space is less than the memory requirements of the current segment, the rank is changed to a lower rank (in other words, current_rank is increased), and the SRAM area may be reset by discarding the checkpoints currently stored in the memory. If there is room in the available memory space, the checkpoints of segment p may be additionally stored in the SRAM space; therefore, the p-th segment has the same rank as a segment with a previously assigned rank. The process above is repeated up to the first layer.

According to the embodiment of the present disclosure, the method for assigning ranks to segments may repeat the last layers of the individual segments in reverse order when recalculation of backpropagation is performed, allocate the memory in reverse order of the output values of the last layers of the respective segments at each repetition, and, if memory allocation is successful, retain the ranks of the segments which have succeeded in the memory allocation.

Also, according to the embodiment of the present disclosure, if memory allocation fails, all memory allocations for the output values of the last layers of the individual segments which have succeeded in memory allocation are removed; memory is allocated again to the output values of the last layers of the individual segments in reverse order, starting from the output value of the last layer of the segment which has encountered a memory allocation failure; for those segments which have encountered a memory allocation failure, their ranks are adjusted to come after the ranks assigned to the segments which have succeeded in memory allocation, where the process above may be repeated up to the segment including the first layer.

To summarize, by referring to the exemplary embodiment of FIG. 5, which is a model consisting of segments 1 to 4 and layers 1 to 12 (segment 1 consists of layers 1 to 3, segment 2 consists of layers 4 to 6, and descriptions of the other segments are omitted for the sake of convenience), when recalculation of backpropagation is performed, segments are repeated in reverse order from segment 4 to segment 1; since memory is successfully allocated to the output value of layer 9, which is the last layer of segment 4 (i.e., the output value of segment 4), and the output value of layer 12, which is the last layer of segment 3 (i.e., the output value of segment 3), the ranks of segment 3 and segment 4 are equally assigned to Rank 1.

Also, since memory allocation fails during the process of repeating from segment 3 to segment 2 in reverse order, all previous memory allocations for the output values of layer 9 of segment 3 and layer 12 of segment 4 are removed; the rank of segment 2, which has encountered a memory allocation failure, is changed to Rank 2, which comes next to Rank 1, which is the rank of segment 3 and segment 4; memory is allocated to the output value of layer 6 of segment 2. The process above is repeated up to segment 1.

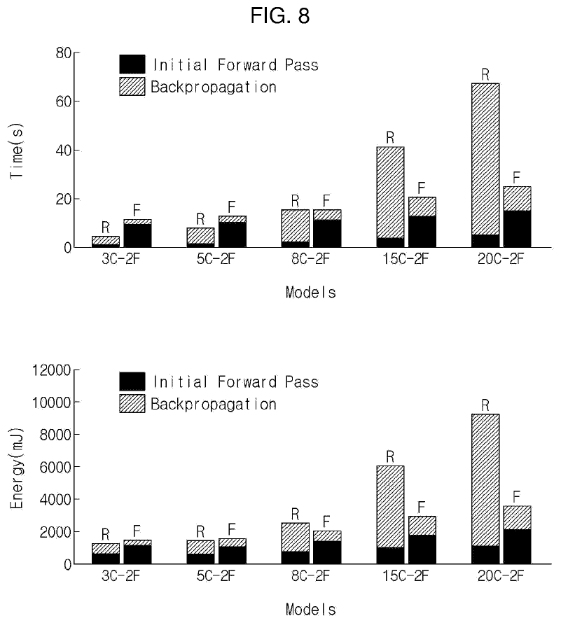

FIG. 8 is a graph showing the amount of time and energy consumed to performed backpropagation for five types of models according to an embodiment of the present disclosure.

The five types of models differ from each other based on the number of convolution layers. For example, 3C-2F indicates three convolution layers and two fully connected layers.

When flash memory was used, in all models, the amount of energy and time consumed during the forward pass calculations was higher than the energy consumed when backward pass calculations were performed for all models. It is so because more time and energy was consumed in recording the results in the flash memory during the forward pass calculations. For models with 5 and 7 layers, the recalculation approach showed faster execution time and higher energy efficiency than the approach employing the flash memory to store intermediate outputs. Specifically, execution time was 38% faster, and energy consumption was 5% lower for a model with 7 layers. However, for the remaining models, due to the recalculation overhead, execution time was delayed by up to 171%, and 154% more energy was consumed.

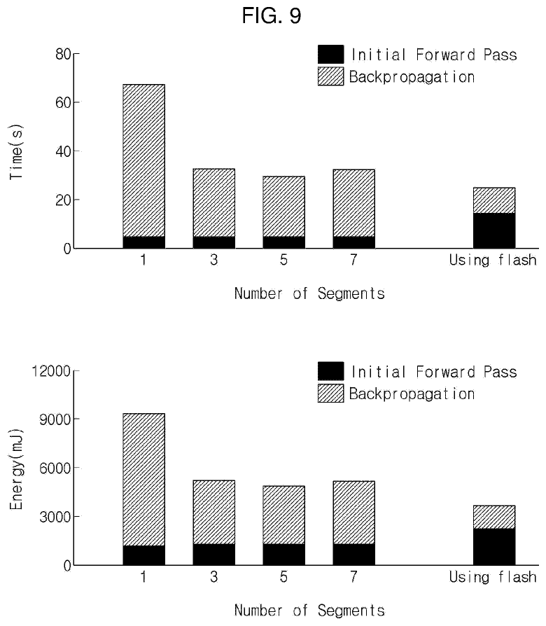

FIG. 9 is a graph comparing a recalculation method according to the prior art, a recalculation method according to an embodiment of the present disclosure, and a method using flash memory for a model with 22 layers according to one embodiment of the present disclosure.

The employed model has 22 layers, among which 20 layers are convolution layers, and two are fully connected layers. Backpropagation was implemented using three methods such as a recalculation method according to the prior art, a recalculation method using segmented checkpoints according to the embodiment of the present disclosure, and a method using flash memory, and the model was partitioned into 3, 5, and 7 segments.

Referring to FIG. 9, when the model is partitioned into 3, 5, and 7 segments, the energy consumption amounts to 5200 mJ, 4870 mJ, and 5130 mJ, respectively. In this case, the average energy consumption is 53% less than the conventional recalculation; however, the segmentation method also consumed 20% more energy on average than using flash memory. The execution time for the segmentation method exhibits a similar pattern to the energy consumption.

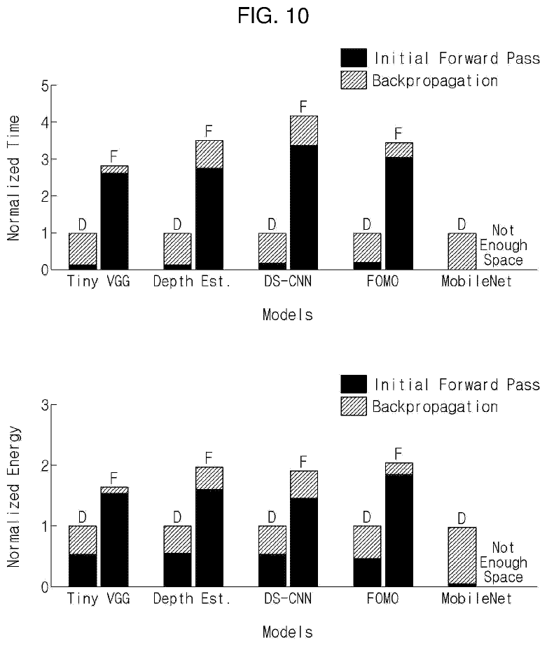

FIG. 10 is a graph illustrating normalized values of five publicly available DNN models according to an embodiment of the present disclosure.

FIG. 10 shows that the recalculation method according to the embodiment of the present disclosure exhibits better performance than the method using flash memory for all five models. Specifically, the DS-CNN took 3.127 seconds and consumed 970 mJ of energy when the model was implemented using the recalculation method according to the embodiment of the present disclosure. On the other hand, when backpropagation of DS-CNN was implemented using flash memory, it took 13.1 seconds and consumed 1826 mJ of energy, showing that the recalculation method according to the embodiment of the present disclosure was 76% faster and used 47% less energy. Likewise, FIG. 10 shows that when Tiny-VGG, Depth Estimation, and FOMO are implemented using the recalculation method according to the embodiment of the present disclosure, the models consumed 50%, 60%, and 51% less energy and operated 68%, 72%, and 71% faster than methods using flash memory, respectively.

Meanwhile, the embodiments of the present disclosure may be implemented in the form of computer-readable code in a computer-readable recording medium. A computer-readable recording medium includes all kinds of recording devices that store data that a computer system may read.

Examples of a computer-readable recording medium include a ROM, a RAM, a CD-ROM, a magnetic tape, a floppy disk, and an optical data storage device. Also, the computer-readable recording medium may be distributed over computer systems connected through a network so that computer-readable code may be stored and executed in a distributed manner. Functional programs, codes, and code segments for implementing the present disclosure may be easily inferred by those programmers in the technical field to which the present disclosure belongs.

Since various modifications may be implemented using the configurations and methods described and illustrated herein without departing from the scope of the present disclosure, all matters included in the detailed description above or shown in the accompanying drawings are introduced only for the illustrative purposes and do not limit the scope of the present disclosure. Accordingly, the scope of the present disclosure should not be limited by the exemplary embodiments described above but should be determined only by the appended claims and their equivalents

1. A recalculation method of backpropagation for selecting layers to store outputs in a memory, the method comprising:
partitioning the entire layers of a model including a plurality of layers into segments;
assigning ranks to the segments;
storing outputs of the last layers of first segments with the highest assigned rank among the segments in the memory simultaneously;
changing the values stored in the memory, which removes, from the memory, output values of the last segments of the first segments stored in the memory after recalculation of backpropagation is performed on the first segments and stores output values of the last layers of second segments, of which the assigned rank immediately follows the rank of the first segments, in the memory simultaneously; and
repeating the changing of the values stored in the memory until output values of the last layers of third segments with the lowest assigned rank are stored in the memory simultaneously.

2. The method of claim 1, wherein the partitioning of the entire layers of the model into segments partitions the entire layers of the model into segments so that recalculation cost is minimized based on the number of floating-point operations per second (FLOPs) of each of the entire layers of the model.

3. The method of claim 2, wherein the partitioning of the entire layers of the model into segments generates all possible cases of subsets for the entire layers of the model and partitions the entire layers of the model into segments so that recalculation cost calculated for each subset is minimized.

4. The method of claim 1, wherein the assigning of the ranks to the segments repeats the last layers of the respective segments in reverse order when recalculation of backpropagation is performed, allocates memory in reverse order of the output values of the last layers of the respective segments at each repetition, and, if the memory allocation is successful, retains the ranks of the segments.

5. The method of claim 4, wherein, if memory allocation fails, the assigning of the ranks to the segments removes all memory allocations for output values of the last layers of the individual segments which have succeeded in the memory allocation, allocates memory again to the output values of the last layers of the individual segments in reverse order, starting from the output value of the last layer of the segment which has encountered a memory allocation failure, and for those segments which have encountered a memory allocation failure, adjusts their ranks to come after the ranks assigned to the segments which have succeeded in memory allocation.

6. A recording medium readable by a digital processing device, in which a program of commands executed by the digital processing device to provide recalculation of backpropagation for selecting layers to store outputs in memory is implemented, recording a program for executing a method of claim 1 in a computer.
